(19) United States
(12) Patent Application Publication
(10) Pub. No.: US 2007/0148997 A1
(43) Pub. Date: Jun. 28, 2007

(54) Flexible circuit

(76) Inventors: Steven Feldman, Cedar Park, TX (US); James R. Shirck, Austin, TX (US)

Correspondence Address: 3M INNOVATIVE PROPERTIES COMPANY, PO BOX 33427, ST. PAUL, MN, 55133-3427, US

(21) Appl. No.: 11/326,681

(22) Filed: Dec. 22, 2005

(51) Int. Cl. H01R 12/00

(52) U.S. Cl. 439/66

(57) ABSTRACT

Provided is an article having a flexible polymeric substrate with an electrically conductive trace having a region with different material properties than the remainder of the trace.

### TECHNICAL FIELD

The present invention relates to flexible circuits, and particularly to flexible circuits for use in electrical and electronic applications.

### BACKGROUND

Flexible circuits are useful in many electrical and electronic applications. For example, they can be used as substrates for electronic components, micro-fluidic devices, in cable assemblies, and as component parts of electrical connectors. In some electrical and electronic applications, the flexible circuit has to withstand a high number of flexural cycles or sharp bend radii. For these applications, the flexible circuit traces are currently made entirely of a material that improves bending cycle fatigue resistance or crack resistance respectively, which negatively impacts the electrical performance of the flexible circuit traces and increases the cost of the flexible circuit.

### SUMMARY OF THE INVENTION

Aspects of the present invention feature a flexible circuit, an article that comprises this flexible circuit, and methods for making such a circuit.

One aspect of the invention provides an article comprising a flexible polymeric substrate having two opposing surfaces and electrically conductive traces on at least one of the substrate surfaces, wherein at least one electrically conductive trace comprises a region having different material properties than the remainder of the trace.

Another aspect of the invention provides an article comprising a bottom housing, a top housing, and a flexible printed circuit comprising a flexible polymeric substrate having two opposing surfaces, and electrically conductive traces on at least one of the substrate surfaces, wherein the electrically conductive traces comprise a region having different material properties, wherein the flexible printed circuit is positioned between the bottom housing and the top housing.

A further aspect of the invention provides a method comprising providing a flexible polymeric substrate having two opposing surfaces and forming electrically conductive traces on at least one of the substrate surfaces, the electrically conductive traces comprising a region having different material properties.

### BRIEF DESCRIPTION OF THE DRAWINGS

FIG. 1 is a top view of an exemplary embodiment of a flexible circuit according to the present invention.

FIG. 2 is a cross-sectional view of the exemplary embodiment of a flexible circuit of FIG. 1.

FIG. 3 is a top view of another exemplary embodiment of a flexible circuit according to the present invention.

FIG. 4 is a cross-sectional view of the exemplary embodiment of a flexible circuit of FIG. 3.

FIG. 5a is a top view of an exemplary embodiment of a flexible circuit according to the invention suitable for incorporating in a connector.

FIG. 5b is a top view of an exemplary embodiment of a flexible circuit according to the invention suitable for incorporating in a connector.

FIG. 6a is a perspective view of the flexible circuit of FIG. 5a in folded form.

FIG. 6b is a perspective view of the flexible circuit of FIG. 5b in folded form.

FIG. 7 is a front view of an exemplary embodiment of a connector in which a flexible circuit such as that shown in FIG. 5a or FIG. 5b has been integrated.

FIG. 8 is an exemplary semi-additive process flow for making a flexible circuit of the present invention without a diffusion barrier.

FIG. 9 is an exemplary semi-additive process flow for making a flexible circuit of the present invention with a diffusion barrier.

### DETAILED DESCRIPTION

In the following detailed description of the preferred embodiments, reference is made to the accompanying drawings that form a part hereof. The accompanying drawings show, by way of illustration, specific embodiments in which the invention may be practiced. It is to be understood that other embodiments may be utilized, and structural or logical changes may be made without departing from the scope of the present invention. The following detailed description, therefore, is not to be taken in a limiting sense, and the scope of the invention is defined by the appended claims.

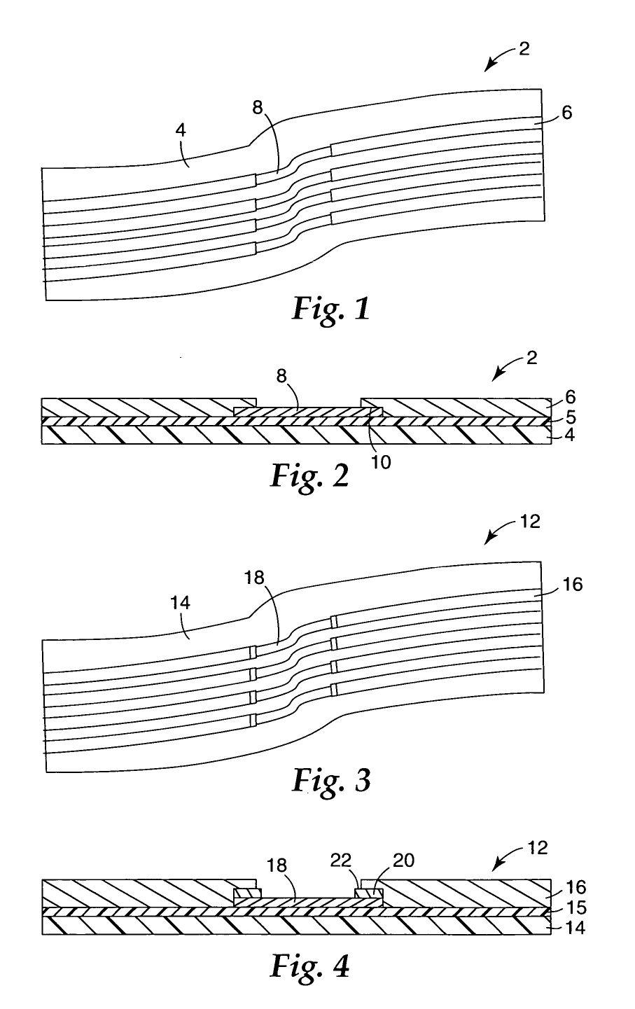

FIGS. 1 and 2 illustrate one embodiment of an article in accordance with the present invention. A flexible circuit 2 includes a flexible polymeric substrate 4 and electrically conductive traces 6 on at least one of the substrate surfaces. The electrically conductive traces 6 comprise a region 8 having different material properties than the remainder of the traces.

In one exemplary embodiment of the present invention, the electrically conductive traces 6 in the region 8 are made from a material substantially the same as the material of the remainder of the traces, but alloyed or compounded with at least one additional element. For example, to improve bending cycle fatigue resistance, the electrically conductive traces 6 in the region 8 can be made from copper, alloyed or compounded with one or more strength-improving element such as beryllium, tin, phosphorus, nickel, cadmium, silver, gold, or zirconium. For the same reason, the electrically conductive traces 6 in the region 8 can be made from gold, alloyed or compounded with one or more strength-improving element, such as cobalt, copper, silver, or nickel. This enables the flexible circuit 2 to withstand a high number of flexural cycles within the region 8 without making the electrically conductive traces 6 entirely of such an alloyed or compounded material, which would negatively impact the electrical performance of the electrically conductive traces 6 and the cost of the flexible circuit 2.

In another exemplary embodiment of the present invention, the electrically conductive traces 6 in the region 8 are made from a material substantially different from the material of the remainder of the traces. For example, where the remainder of the traces 6 are made from copper, to improve crack resistance, the electrically conductive traces 6 in the region 8 can be made from one or more of a more ductile material than copper, such as conductive polymers, gold, palladium, platinum, aluminum, or silver. This enables the flexible circuit 2 to withstand sharp bend radii within the region 8 without making the electrically conductive traces 6 entirely of such a substantially different material, which would again negatively impact the electrical performance of the electrically conductive traces 6 and the cost of the flexible circuit 2.

The electrical performance of the electrically conductive traces 6 and the cost of the flexible circuit 2 may be positively impacted by additionally giving the electrically conductive traces 6 in the region 8 different geometrical properties than the remainder of the traces. For example, to improve bending cycle fatigue resistance, the electrically conductive traces 6 in the region 8 can be made thinner or narrower than the remainder of the traces.

The substrate of the present invention is a flexible polymer layer. Suitable substrates for the present invention are those that can be metallized. In various embodiments, it is preferable for the substrate material to be one or more of inert, heat stable, highly dielectric, and low cost. Various types of substrates can be used depending on the end user needs. If chemical milling is required, then polyimide or polycarbonate might be preferred. If no chemical milling is required, then polyester may be an appropriate choice due to its low cost. Suitable substrate materials for the present invention include, but are not limited to, polyimide, polyester, polyvinyl chloride, acrylate, polyolefin, polyester terephthalate, polyethylene naphthalate, polycarbonate, and liquid crystal polymers. Suitable thicknesses will depend on the intended use, but are typically about 10 μm to about 600 μm.

The electrically conductive traces of the present invention typically function to transmit electrical signals from one part of the substrate to another. Suitable traces for the present invention are those that can transmit electrical signal, preferably with a low signal loss and at a high signal speed, and can withstand a high number of flexural cycles or sharp bend radii. To enable a high number of flexural cycles or sharp bend radii, the electrically conductive traces of the present invention include a region having different material properties than the remainder of the traces. Suitable electrically conductive trace materials in this region include copper, beryllium, tin, phosphorus, nickel, cadmium, silver, gold, zirconium, palladium, conductive polymers, platinum, aluminum, cobalt, or other suitable materials. Suitable electrically conductive trace materials in the remainder of the traces include copper, gold, or other suitable materials.

The article of the present invention may optionally include a suitable flash layer 5 positioned between the flexible polymeric substrate 4 and the electrically conductive traces 6. A suitable flash layer would enhance adhesion of the electrically conductive traces 6 to the flexible polymeric substrate 4. Suitable flash layer materials include chrome, nickel-chrome, or other suitable metals. The flash layer may be deposited by plating, sputtering, evaporation deposition, using an adhesive, or other suitable means.

Although the material in the remainder of the electrically conductive traces 6 can be electrically connected to the material in the region 8 of the traces side to side (not shown), the material in the remainder of the electrically conductive traces 6 can overlap the material in the region 8 of the traces to form a conductive bond 10, as illustrated in FIG. 2, or vise versa (not shown). The conductive bond 10 improves the electrical and mechanical connection between the material in the region 8 and the material in the remainder of the traces.

FIGS. 3 and 4 illustrate another embodiment of an article in accordance with the present invention. A flexible circuit 12 includes a flexible polymeric substrate 14 and electrically conductive traces 16 on at least one of the substrate surfaces. The electrically conductive traces 16 comprise a region 18 having different material properties than the remainder of the traces. The region 18 includes a diffusion barrier 20, which eliminates diffusion of the material in the remainder of the traces (e.g. copper) into the material in the region 8 (e.g., gold). The diffusion barrier 20 helps the circuit to better tolerate solder processes and continuously high operating temperatures. Suitable diffusion barrier materials include, but are not limited to, nickel, tantalum, ruthenium, palladium. The diffusion barrier may include a tarnish creep barrier 22, which prevents tarnish from the material in the remainder of the traces (e.g., copper) from creeping over the material in the region 8 (e.g., gold) when a topcoat is not applied.

Similar to the embodiment illustrated in FIGS. 1 and 2, this embodiment may optionally include a suitable flash layer 15 positioned between the flexible polymeric substrate 14 and the electrically conductive traces 16.

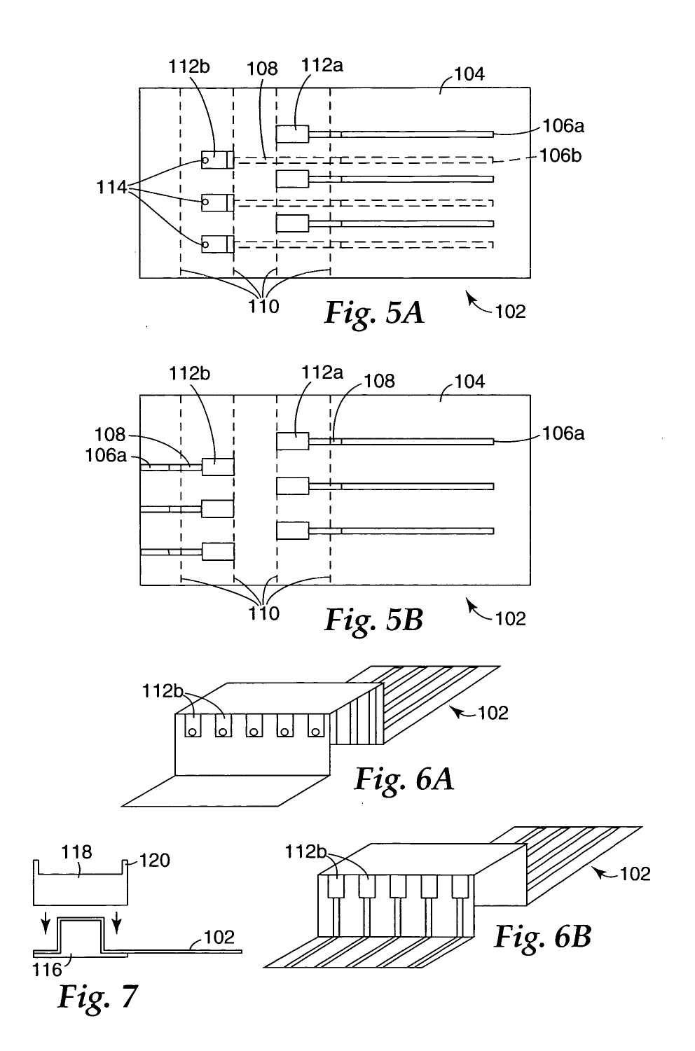

Another embodiment of an article in accordance with the present invention is illustrated in FIG. 5a. A flexible circuit 102 comprises a flexible polymeric substrate 104 on which electrically conductive traces 106a and 106b are formed on the top side and bottom side respectively. The electrically conductive traces 106a and 106b are electrically connected to contact surfaces 112a and 112b respectively. Electrical connection of the electrically conductive traces 106b to the contact surfaces 112b can be achieved by using electrical vias 114. The electrical vias 114 bring the electrical connection from the bottom side of the substrate (electrically conductive traces 106b) to the top side of the substrate (contact surfaces 112b).

A further embodiment of an article in accordance with the present invention is illustrated in FIG. 5b. A flexible circuit 102 comprises a flexible polymeric substrate 104 on which electrically conductive traces 106a are formed on the top side. The electrically conductive traces 106a are electrically connected to contact surfaces 112a and 112b.

In the exemplary embodiments of the present invention illustrated in FIG. 5a and FIG. 5b, the electrically conductive traces 106a and 106b comprise a region 108 having different material properties than the remainder of the traces. The embodiments include fold lines 110 positioned inside the region 108. The different material properties in the region 108 allow the flexible circuit 102 to be bent at the fold lines 110 with a small inside bend radius, while improving the crack resistance of the electrically conductive traces in the region. The inside bend radius is typically less than ten times the thickness of the substrate 104. It is to be understood that each fold line can have its own individual region, as opposed to the exemplary embodiments illustrated in FIG. 5a and FIG. 5b, where the four fold lines 110 share a single region 108.

FIG. 6a and FIG. 6b illustrate the embodiment of FIG. 5a and FIG. 5b respectively in folded form. The flexible circuit 102 is folded at the fold lines 110 such that the two rows of contact surfaces 112a and 112b are positioned in parallel planes. This configures the contact surfaces 112a and 112b for contacting electrical contacts of an electrical connector (not shown). One exemplary way of obtaining an adequate electrical connection is for the electrical connector to have active spring members that will interface with the contact surfaces 112a and 112b.

FIG. 7 illustrates a flexible circuit such as that shown in FIG. 5a or FIG. 5b positioned between a bottom housing 116 and a top housing 118. One of the functions of the bottom housing 116 is to support the flexible circuit 102. Functions of the top housing 118 include capturing the flexible circuit 102 and providing the proper mechanical and electrical connector mating structure. The bottom housing 116 and the top housing 118 can be made of any suitable material. Preferably, a dielectric material, such as a plastic, is used. When an electrically conductive material, such as a metal, is used, electrical insulation from the electrically conductive traces 106a and 106b, the contact surfaces 112a and 112b, and relevant parts of the mating electrical connector is to be taken into consideration. For example, an insulating layer (not shown) can separate the electrically conductive traces 106b from electrically contacting the bottom housing 116.

The top housing 118 may be mechanically fastened to the bottom housing 116 to help hold the flexible circuit in position between the bottom housing 116 and the top housing 118. Mechanical fastening can be accomplished by means known in the art, such as latches, snaps, screws, adhesives, friction, etc.

Optionally, the bottom housing 116 and the top housing 118 may be one unitary housing. In a first exemplary embodiment, the bottom housing 116 and the top housing 118 are injection molded as one unitary housing, into which the flexible circuit 102 is then inserted. In a second exemplary embodiment, a hinge connects the bottom housing 116 and the top housing 118, whereby the hinge, the bottom housing 116, and the top housing 118 are injection molded as one unitary housing. The flexible circuit 102 is then positioned onto the bottom housing 116, after which the top housing 118 is hinged over to capture the flexible circuit 102. In a third exemplary embodiment, the flexible circuit 102 is captured between the bottom housing 116 and the top housing 118 while injection molding the bottom housing 116 and the top housing 118 as one unitary housing. This would generally be referred to as insert molding the flexible circuit 102.

The article according to the present invention can be made by various additive or subtractive processes, or a combination of the two, such as a semi-additive process, which may include subtractively removing sputtered metal and additively plating metal.

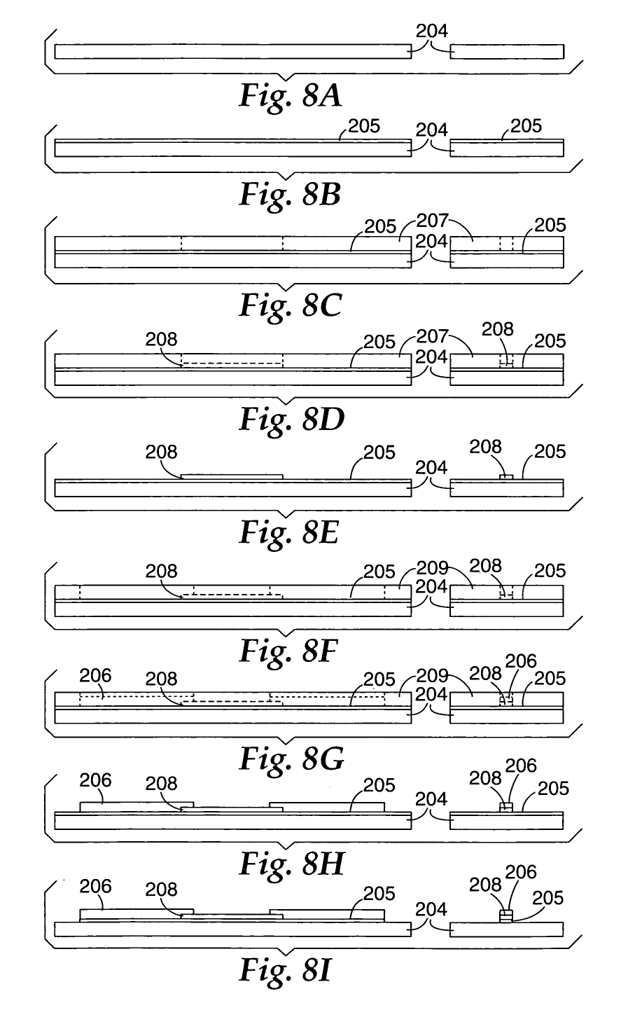

In a suitable semi-additive process, a flexible polymeric substrate 204 is first provided, as illustrated in FIG. 8a. The dielectric substrate may be a polymer film made of, for example, polyester, polyimide, liquid crystal polymer, polyvinyl chloride, acrylate, polycarbonate, or polyolefin having a thickness of about 10 μm to about 600 μm.

As shown in FIG. 8b, the dielectric substrate has an optional flash layer 205 of chrome, nickel-chrome or other conductive metal deposited onto at least one side, using a vacuum sputtering or evaporation technique, or other suitable method.

As shown in FIG. 8c, an aqueous or solvent-processable photoresist 207, either negative or positive, is then laminated or coated onto the optional flash layer 205 on the flexible polymeric substrate 204 using standard laminating techniques, e.g. with hot rollers, or coating techniques, e.g. knife coating, die coating, gravure roll coating. The photoresist is then exposed to ultraviolet light or the like, through a mask or phototool, and developed to obtain a desired photoresist pattern used to form region 208 of the electrically conductive traces 206 as shown in FIG. 8d.

Regions 208 of the electrically conductive traces 206 are formed by plating the exposed portions of the optional flash layer 205 with a suitable metal, using standard electroplating of electroless plating methods, until the desired thickness is achieved.

As illustrated in FIG. 8e, the photoresist 207 is then stripped off in a 2-5% solution of an alkaline metal hydroxide at from about 20° C. to about 80° C., preferably from about 20° C. to about 60° C.

Subsequently, as shown in FIG. 8f, an aqueous or solvent-processable photoresist 209, either negative or positive, is then laminated or coated onto the optional flash layer 205 on flexible polymeric substrate 204 using standard laminating techniques, e.g. with hot rollers, or coating techniques, e.g. knife coating, die coating, gravure roll coating. The photoresist is then exposed to ultraviolet light or the like, through a mask or phototool, and developed to obtain a desired photoresist pattern used to form the remainder of the electrically conductive traces 206 as shown in FIG. 8g.

The remainder of the electrically conductive traces 206 is formed by plating the exposed portions of the optional flash layer 205 with a suitable metal, using standard electroplating of electroless plating methods, until the desired thickness is achieved. Optionally, the remainder of the electrically conductive traces 206 can overlap the plated material in the region 208 to form a conductive bond 210. The conductive bond 210 improves the electrical and mechanical connection between the material in the region 208 and the material in the remainder of the traces.

As illustrated in FIG. 8h, the photoresist 209 is then stripped off in a 2-5% solution of an alkaline metal hydroxide at from about 20° C. to about 80° C., preferably from about 20° C. to about 60° C.

Finally, as shown in FIG. 8i, the flash layer 205 is removed where exposed. It can be removed with appropriate etchants to provide the final circuit structure.

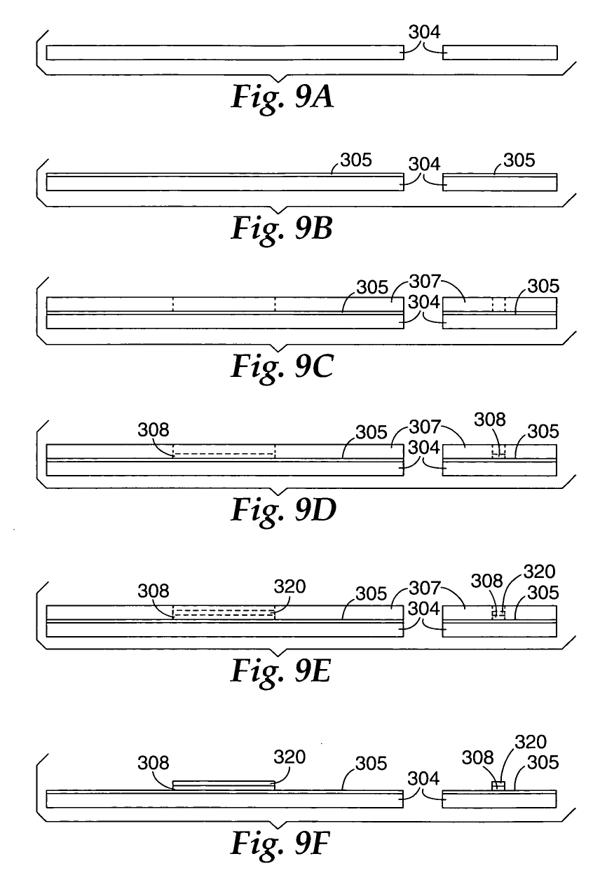

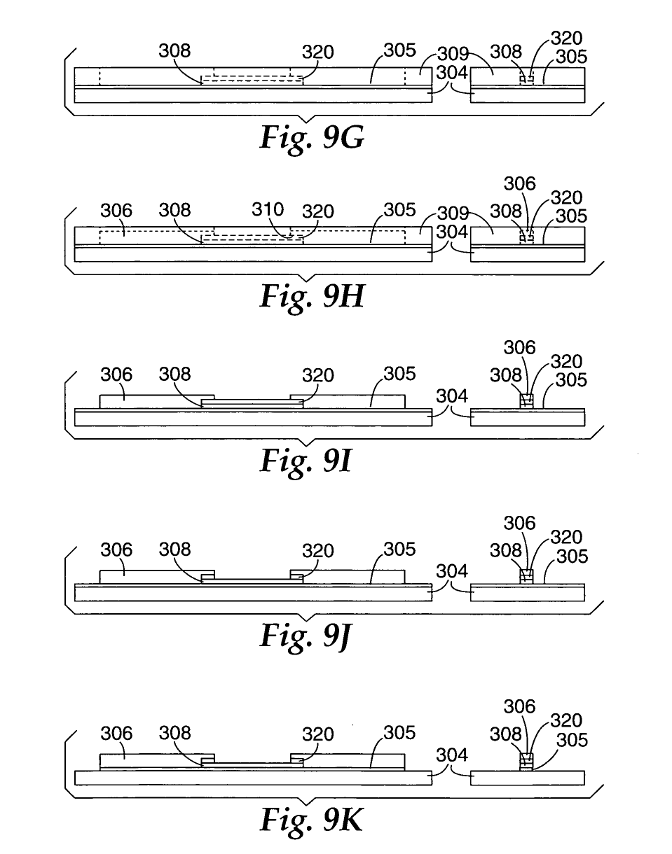

In another suitable semi-additive process, a flexible polymeric substrate 304 is first provided, as illustrated in FIG. 9a. The dielectric substrate may be a polymer film made of, for example, polyester, polyimide, liquid crystal polymer, polyvinyl chloride, acrylate, polycarbonate, or polyolefin having a thickness of about 10 μm to about 600 μm.

As shown in FIG. 9b, the dielectric substrate has an optional flash layer 305 of chrome, nickel-chrome or other conductive metal deposited onto at least one side, using a vacuum sputtering or evaporation technique, or other suitable method.

As shown in FIG. 9c, an aqueous or solvent-processable photoresist 307, either negative or positive, is then laminated or coated onto the optional flash layer 305 on the flexible polymeric substrate 304 using standard laminating techniques, e.g. with hot rollers, or coating techniques, e.g. knife coating, die coating, gravure roll coating. The photoresist is then exposed to ultraviolet light or the like, through a mask or phototool, and developed to obtain a desired photoresist pattern used to form region 308 of the electrically conductive traces 306 as shown in FIG. 9d.

Regions 308 of the electrically conductive traces 306 are formed by plating the exposed portions of the optional flash layer 305 with a suitable metal, using standard electroplating of electroless plating methods, until the desired thickness is achieved.

FIG. 9e shows the formation of diffusion layer 320. The diffusion layer 320 is formed by plating region 308 of the electrically conductive traces 306 with a suitable metal, using standard electroplating of electroless plating methods, until the desired thickness is achieved.

As illustrated in FIG. 9f, the photoresist 307 is then stripped off in a 2-5% solution of an alkaline metal hydroxide at from about 20° C. to about 80° C., preferably from about 20° C. to about 60° C.

Subsequently, as shown in FIG. 9g, an aqueous or solvent-processable photoresist 309, either negative or positive, is then laminated or coated onto the optional flash layer 305 on the flexible polymeric substrate 304 using standard laminating techniques, e.g. with hot rollers, or coating techniques, e.g. knife coating, die coating, gravure roll coating. The photoresist is then exposed on at least one side to ultraviolet light or the like, through a mask or phototool, and developed to obtain a desired photoresist pattern used to form the remainder of the electrically conductive traces 306 as shown in FIG. 9h.

The remainder of the electrically conductive traces 306 is formed by plating the exposed portions of the optional flash layer 305 with a suitable metal, using standard electroplating of electroless plating methods, until the desired thickness is achieved. Optionally, the remainder of the electrically conductive traces 306 can overlap the plated material in the region 308 to form a conductive bond 310. The conductive bond 310 improves the electrical and mechanical connection between the material in the region 308 and the material in the remainder of the traces.

As illustrated in FIG. 9i, the photoresist 309 is then stripped off in a 2-5% solution of an alkaline metal hydroxide at from about 20° C. to about 80° C., preferably from about 20° C. to about 60° C.

FIG. 9j shows the process step of removing the diffusion layer 320 where exposed. It can be removed with appropriate etchants. The portions of the diffusion layer that remain, also referred to as diffusion barriers, eliminate diffusion of the material in the remainder of the traces (e.g. copper) into the material in the region 308 (e.g. gold).

Finally, as shown in FIG. 9k, the flash layer 305 is removed where exposed. It can be removed with appropriate etchants to provide the final circuit structure.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the mechanical, electromechanical, and electrical arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. An article comprising:
a flexible polymeric substrate having two opposing surfaces; and
electrically conductive traces on at least one of the substrate surfaces, wherein at least one electrically conductive trace comprises a region having different material properties than the remainder of the trace.

2. The article of claim 1, wherein the region comprises a material substantially the same as a material of the remainder of the trace, alloyed or compounded with at least one additional element.

3. The article of claim 2, wherein the at least one additional element improves bending cycle fatigue resistance.

4. The article of claim 2, wherein the at least one additional element improves ductility.

5. The article of claim 1, wherein the region comprises a material substantially different from the material of the remainder of the trace.

6. The article of claim 1, wherein the region has different geometrical properties than the remainder of the trace.

7. The article of claim 1, wherein the region comprises a material selected from the group consisting of copper, beryllium, tin, phosphorus, nickel, cadmium, silver, gold, zirconium, palladium, conductive polymers, platinum, aluminum, and cobalt.

8. The article of claim 1, wherein the remainder of the trace comprises a material selected from the group consisting of copper and gold.

9. The article of claim 1, wherein the region further comprises a diffusion barrier.

10. The article of claim 9, wherein the diffusion barrier comprises a material selected from the group consisting of nickel, tantalum, ruthenium, and palladium.

11. The article of claim 9, wherein the diffusion barrier comprises a tarnish creep barrier.

12. The article of claim 1, further comprising a flash layer positioned between the flexible polymeric substrate and the electrically conductive traces.

13. An article comprising:
a bottom housing;
a top housing; and
a flexible printed circuit comprising:
a flexible polymeric substrate having two opposing surfaces; and
electrically conductive traces on at least one of the substrate surfaces, wherein the electrically conductive traces comprise a region having different material properties,
wherein the flexible printed circuit is positioned between the bottom housing and the top housing.

14. The article of claim 13, wherein the flexible printed circuit has an inside bend radius of less than 10 times the substrate thickness.

15. The article of claim 13, wherein the bottom housing is a dielectric bottom housing.

16. The article of claim 13, wherein the top housing is a dielectric top housing.

17. The article of claim 13, wherein the top housing is mechanically fastened to the bottom housing.

18. The article of claim 13, wherein the bottom housing and the top housing are one unitary housing.

19. The article of claim 13, further comprising contact surfaces electrically connected to the electrically conductive traces, the contact surfaces configured for contacting electrical contacts of an electrical connector.

20. A method comprising:
providing a flexible polymeric substrate having two opposing surfaces; and
forming electrically conductive traces on at least one of the substrate surfaces, the electrically conductive traces comprising a region having different material properties.
